(19) United States
(12) Patent Application Publication
(10) Pub. No.: US 2008/0276769 A1
(43) Pub. Date: Nov. 13, 2008

(54) Automatic Driver Device and Joining Process

(76) Inventors: Vitus Zach, Augsburg (DE); Rudolf Zimmer, Wadern (DE)

Correspondence Address: MCGLEW & TUTTLE, PC, P.O. BOX 9227, SCARBOROUGH STATION, SCARBOROUGH, NY, 10510-9227, US

(21) Appl. No.: 10/596,273

(22) PCT Filed: Dec. 9, 2004
(86) PCT No.: PCT/EP2004/014023

§ 371 Date: Jun. 7, 2006

(30) Foreign Application Priority Data
Dec. 12, 2003 (DE) 203 19 310.5

(51) Int. Cl. B25B 23/06; B23P 21/00; B23P 11/00

(52) U.S. Cl. 81/434; 29/784; 29/430

(57) ABSTRACT

An automatic driver device (3) for joining components (2) of a driving station (1) is provided including a base support (8) that is provided with several automatic driving tools (4, 5), the driving tools being mounted thereupon so as to be movable in a multiaxial fashion. The movement is via adjusting mechanisms (9, 16, 17, 24, 25). Several of the automatic driving tools (4, 5) are combined into at least one screwdriver group and are jointly mounted so as to be movable on the base support (8) by one of the adjusting mechanisms (9). One or several driving tools (4, 5) can be additionally mounted within the screwdriver group (6, 7) so as to be movable relative to each other by at least one other adjusting mechanism (9, 17, 25).

### CROSS REFERENCE TO RELATED APPLICATIONS

This application is a United States National Phase application of International Application PCT/EP2004/014023 and claims the benefit of priority under 35 U.S.C. § 119 of German Utility Model 203 19 310.5 filed Dec. 12, 2003, the entire contents of which are incorporated herein by reference.

### FIELD OF THE INVENTION

The present invention pertains to an automatic screw, bolt or nut driver device and a joining process. The term driver or drive tool refers to a device that is used to drive either a nut or a bolt. Driving refers to a bolting or screwing action.

### BACKGROUND OF THE INVENTION

Such an automatic driver device for joining together body parts by means of an inserted spindle carrier is known from DE 37 29 084 A1. The device is comprised of a basic carrier and two automatic driving tools, which are mounted thereon such that they can be displaced along two axes and screwingly mesh (rotate to run/bolt) with the spindle extensions located at the spindle carrier. The adjusting means used for the motion along two axes comprises a cross arm each, which is mounted in the circular rail-like frame of the basic carrier in a longitudinally displaceable manner. An individual driver tools is mounted at each cross arm by means of a running carriage in an axially displaceable manner. This biaxial adjusting means has a shape similar to that of a crane running carriage. The design limits the number of degrees of freedom of motion of the driving tools, which must be adjusted individually. The consequence of this is that each driving tool must perform a plurality of screwing operations at different points and must travel over corresponding displacement paths for this. This is disadvantageous for the cycle time.

### SUMMARY OF THE INVENTION

The object of the present invention is to improve the automatic driving technique.

The present invention presents a driving technique that has the advantage that the number of driving tools can be changed and especially increased as needed. Furthermore, the possibilities of motion and adjustment of the driving tools improve. A plurality of driving tools can be integrated into driving groups on a carriage unit. Adjustment can be made to a driving group, and adjustment within the driving group is also possible, if needed, due to the mutual adjustability of the carriage steps, e.g., their ability to be telescoped.

Furthermore, the device offers the advantage that the driving tools may have individual additional transverse adjustments in order to be able to be adjusted along two or more axes in the principal plane of the basic carrier. Due to this grouping, the carriage units and the transverse adjustments require less space, which offers, on the other hand, the possibility of accommodating an increasing number of driving tools in any desired position and with wide ranges of motion on a basic carrier.

The individual carriage unit and the other adjusting means have a smaller width and length than the basic carrier. This makes it possible to accommodate a plurality of carriage units next to one another in the longitudinally directed x axis and/or the transversely directed y axis of the basic carrier. As a result, the driving tools can be adjusted in relation to one another along one axis or along a plurality of axes in the longitudinal and transverse directions without the risk of collision. This is not possible in the prior-art designs of nut or bolt driver tools with the cross arm.

Due to the freely selectable equipment with driving tools and the increased mobilities, the driver device according to the invention offers great flexibility in set-up and adjustment, but also in case of retrofitting to different components, especially vehicle bodies, and spindle carriers that possibly belong to them. This is advantageous above all during the final assembly of motor vehicles, because models frequently change here, and even the body types, e.g., limousine and station wagon, etc., may frequently change within the same model. Variations of the underbody and the attachment points arise, e.g., due to different vehicle lengths, engine and transmission types, all-wheel drive, exhaust systems, sports or comfort type chassis, etc. Variations are also possible in the positions of the underbody. The driver device can now be adapted rapidly and simply.

Due to the freely selectable number of driving tools, the number of driving operations can be increased or the cycle time reduced as desired. This improves the utilization and economy. In addition, it is possible to select and set any desired driving sequences due to the individual driving tools, which can be actuated independently from one another. This may be advantageous, e.g., to counter deformations or warping the components.

The driver device has, furthermore, the advantage that it can be withdrawn and extended with the basic carrier as a whole via a chassis and a preferably floor-bound guide at an assembly station, especially in a bolt or nut driving station. This makes possible, especially in case of possible disturbances, a rapid changeover to a manual driving operation, in which case the driver device can be removed from the work area under the body or the spindle carrier in order to create space for workers with hand-held driving tools.

The driver device being claimed is preferably provided for nut or bolt fastening/driving action on the underside of components or vehicle bodies. This may be an indirect driving function shown in the drawings with the insertion of a mobile spindle carrier with spindle extension. As an alternative, direct driving action is possible on the body. Possible height adjustments can be achieved in a simple and rather uncomplicated manner because of the design being claimed by means of bases at the driving tools. As a result, the driving tools themselves do not need to have excessively great paths of adjustment in height.

In addition, the driving tools can have improved and enlarged freedoms of movement of their own for their driving units. Height and/or pivoting adjustments are possible now. The driving unit with the driving spindle and the spindle drive can be adjusted as a whole in relation to the bracket, which simplifies the design embodiment and the control. Due to the spindle drives and the different adjusting means being connected to a common control, fully automatic and highly flexible operation of the driver device is possible.

Furthermore, the driver device may have any design in height. In particular, despite the fact that the paths of adjustment are kept small, it is possible to obtain great overall heights due to the design of the bracket, which is advantageous for creating a sufficiently large free space for a manual driving activity in case of disturbance. In addition, an essentially identical interference contour can be obtained for all driving tools.

The driver device makes it, furthermore, possible to accommodate at the basic carrier a centering and lifting unit, which preferably has an additional vertical mobility for lifting out and introducing the components and the spindle carrier.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a simplified schematic side view of a vehicle body to vehicle chassis fastening station utilizing an automatic driver device;

FIG. 2 is a perspective view of the driver device of FIG. 1;

FIG. 3 is a top view of a driver device that differs in details;

FIG. 4 shows a side view of a driver device according to FIG. 2;

FIG. 5 is a view of a height-adjustable driver tools;

FIG. 6 is another view of a height-adjustable driver tools;

FIG. 7 is a perspective view of a height-adjustable driver tools;

FIG. 8 is a view of a pivotable and height-adjustable driver tools;

FIG. 9 is another view of a pivotable and height-adjustable driver tools; and

FIG. 10 is another view of a pivotable and height-adjustable driver tools.

### DESCRIPTION OF THE PREFERRED EMBODIMENT

Referring to the drawings in particular, the present invention pertains to an automatic driver device (3) and, in addition, also to a driving station (1) equipped therewith.

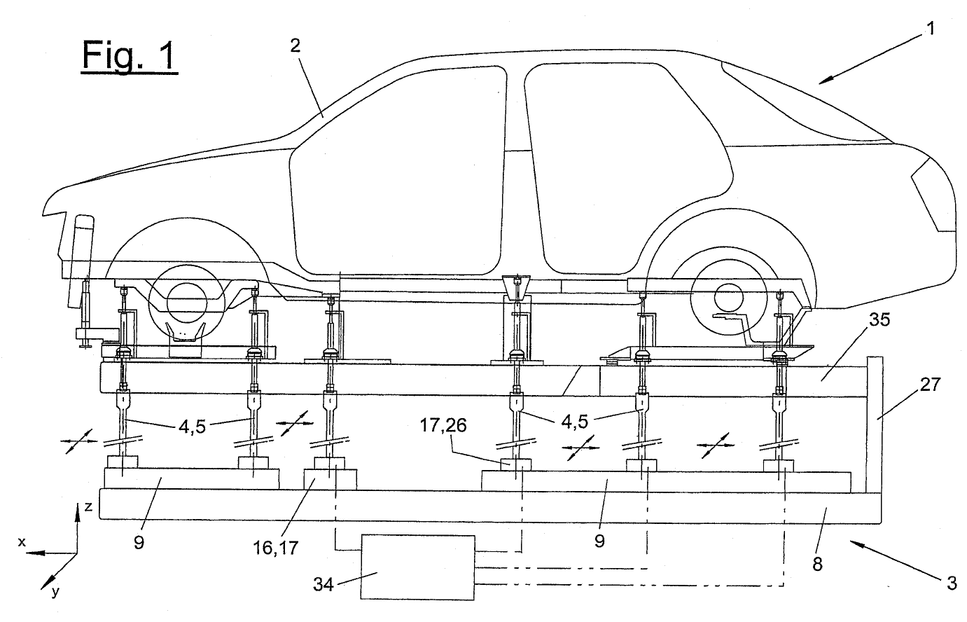

FIG. 1 shows a detail of an assembly station (1), which is designed as a driving station for one or more components (2) here. The component is preferably a vehicle body and parts thereof here. For example, chassis parts, especially a complete underbody with engine, axles, etc., are connected and fastened or bolted to the body here. The body (2) or other components are brought into the driving station (1) with a conveyor, not shown, e.g., a C-type suspension gear and again removed after the assembly operation. The components (2) are mounted on suitable support and clamping devices in the correct position.

The chassis parts are brought into the assembly station (1) with a suitable aggregate carrier, which may also be a spindle carrier (35) with a plurality of spindle extensions, which are positioned corresponding to the joining points and are possibly mobile. As an alternative, the spindle carrier (35) may be arranged separately from the aggregate carrier. It may otherwise have any desired and suitable design, e.g., corresponding to DE-37 29 084 A1.

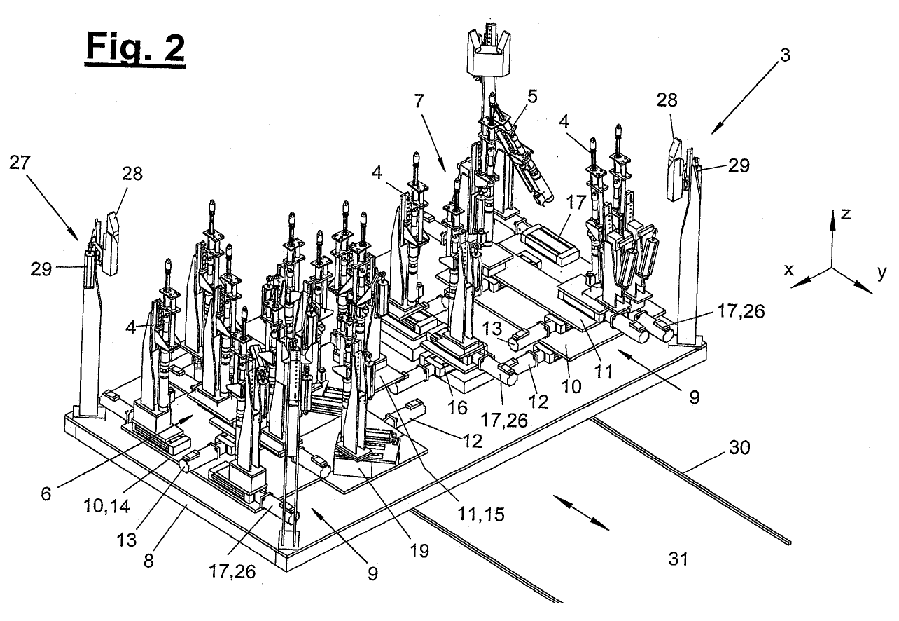

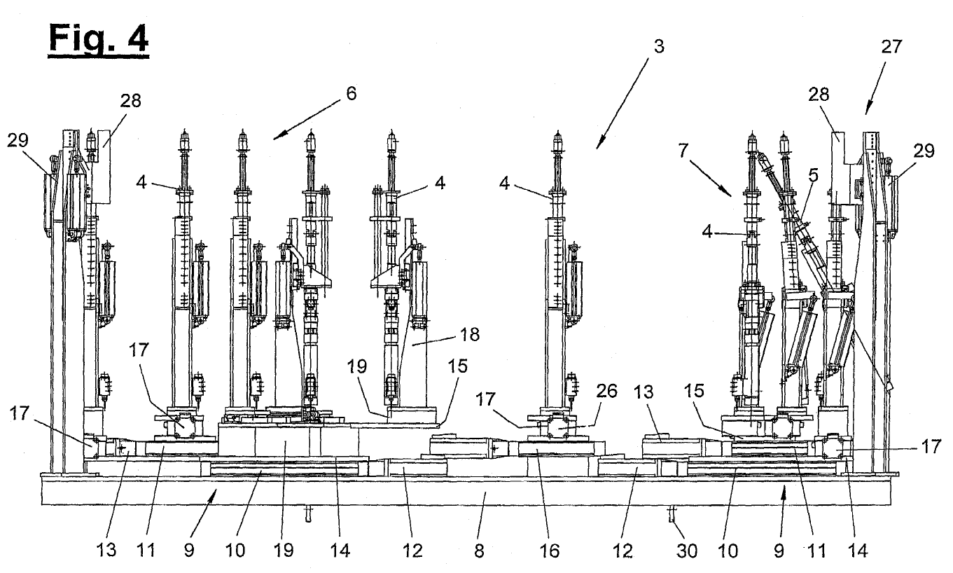

An automatic driver device (3), which is schematically shown in FIG. 1 and in greater detail in FIGS. 2 through 10, is used for the assembly operation and for driving together the components. It comprises at least one basic carrier (8) and a plurality of driving tools (4, 5) with adjusting means (9, 16, 17, 24, 25).

The driving operation takes place via the intermediary of the spindle carrier (35) shown in FIG. 1. The driving tools (4, 5) are fed to the spindle extensions and caused to mesh by their driving heads (22) with the screwdriver mounts located at the bottom. The spindle extensions have been equipped in advance with the corresponding fasteners, typically screw screws or nuts.

As an alternative, the driving operation may be carried out directly at the components (2) by means of the driving tools (4, 5) in an embodiment that is not shown, in which case the driving tools (4, 5) are equipped with the corresponding fasteners, typically screws or nuts.

The driving device (4, 5) are present in a large numbers. The number of single drive tools may correspond to the number of fastening points on the component (2) and the number of spindle extensions. If different types of components are processed in a flexible mix, the number of driving tools (4, 5) may be selected according to the largest occurring number of fastening points and spindle extensions.

The joining process is carried out from below in the embodiment being shown with upright driving tools (4, 5) that can be fed in the z axis. This arrangement may also be different in an alternative.

The basic carrier (8) has a plate-like design and preferably has a parallelepipedic shape. It may be plate-like with a closed upper surface and optionally a closed lower surface. As an alternative, it may also be a lattice frame. The basic carrier (8) forms a plane load-bearing structure in this case.

The basic carrier (8) may be height-adjustable by means of a suitable lifting device (not shown). The basic carrier (8) preferably has a chassis on the underside, with which it can be withdrawn and extended at the driving station (1). A suitable guide (30), e.g., a straight rail guide, may be present for this at the bottom (30) of the station. As an alternative, rotation mobility or other suitable kinematics may also be present. The basic carrier (8) can be moved as a result with a suitable drive between a working position at or under the components (2) and a withdrawn inoperative position while the working space at or under the components (2) is released.

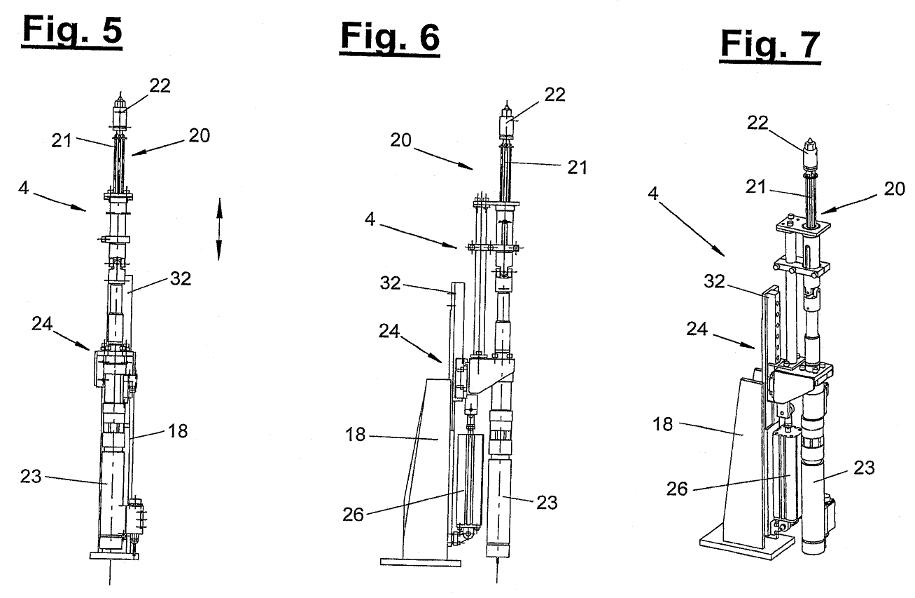

A plurality of driving tools (4, 5) are arranged individually or in driver/driving groups (6, 7) at the basic carrier (8). They are preferably located all on the top side of the basic carrier (8) and project vertically or obliquely upward. The design of the driving tools (4, 5) will be explained below on the basis of FIGS. 5 through 10.

The driving tools (4, 5) are mounted in the main plane of the basic carrier (8) such that they are movable in one direction or two directions along the x and y axes by means of adjusting mechanism or means (9, 16, 17). The x axis extends here along the driving station (1) and the transfer line. At least one of the adjusting means is designed here as a multistep carriage unit (9) or as a carriage unit that can be telescoped or cascaded.

The carriage unit (9) has a plurality of carriage steps (10, 11), which are movable in relation to one another along at least one linear axis relative to one another, can be controlled separately, are mounted next to one another and are preferably arranged one on top of another in the exemplary embodiment being shown. The respective upper carriage step (11) is supported now on the lower carriage step (10) and is movable in relation to this in the sense of a telescopic or cascading arrangement. The first and lower carriage step (10) is mounted here movably on the top side of the basic carrier (8) in a suitable manner with a sliding or rolling bearing. The second carriage step (11) is mounted movably on the first carriage step (10) in a corresponding manner. Additional carriage steps can be arranged in the same manner in a cascade or in a telescopic arrangement one on top of another or optionally also next to one another. For example, two or more carriage steps may be mounted on the first, lower carriage step (10), and these are now preferably movable separately and independently from one another.

The different carriage steps (10, 11) of the multistep carriage unit (9) are, e.g., all guided telescopically in the same direction. Mobility is present along one axis only, e.g., along the x axis, in the embodiment being shown. As an alternative, there also may be mobility along the y axis or even with oblique direction along the x axis and the y axis.

The carriage steps (10, 11) are formed by a preferably plate-shaped subcarrier (14, 15) with a corresponding controllable carriage drive (12, 13), e.g., an electric motor drive, and the aforementioned guiding sliding or rolling guide. One or more driving tools (4, 5) are arranged at the desired positions on the subcarriers (14, 15), which are preferably directed in parallel to the surface of the basic carrier (8). The height differences occurring between the carriage slides along the z axis between the driving tools (4, 5) can be compensated by accurately fitting bases (19) or the like. Fixed oblique positions can also be obtained with the bases (19).

The driving tools (4, 5) located on a multistep carriage unit (9) form a drive group (6, 7) each. This drive group (6, 7) is adjustable with the first carriage step (10) as a whole or together on the basic carrier (8) by the motion of the carriage. By actuating the subsequent carriage steps (11), the driving tools (4, 5) can be adjusted relative to one another within the drive group (6, 7).

The carriage steps (10, 11) are preferably mounted next to one another in one direction, with a linear axis in the above-mentioned manner and are mutually adjustable. As an alternative, rotary mobility or linear mobility along another linear axis may also be present between the carriage steps (10, 11). More complex kinematics with a plurality of axes and direction superimpositions are also possible. This mutual mounting in different directions is called a cascade arrangement.

The multistep carriage unit (9) has a smaller width and/or length than the basic carrier (8). It may be positioned on the basic carrier (8) at any desired and suitable point. Due to the small base, a plurality of carriage units (9) may be arranged next to one another on the basic carrier (8). In the embodiment being shown, two multistep carriage units (9) are arranged in the direction of the x axis at spaced locations one behind the other. As an alternative or in addition, a plurality of carriage units (9) may be arranged next to one another in the direction of the y axis.

The driver device (3) may, moreover, have one or more driving tools (4, 5) or screwdriver groups on a one-step carriage or longitudinal adjusting means (16). For example, two such adjusting means (16) are arranged between the multistep carriage units (9) in the embodiment being shown.

To impart an additional mobility on the driving tools (4, 5), i.e., in the y direction, one or more additional adjusting means (17) may be present in the form of transverse adjusting means. The driver tools (4, 5) preferably has a transverse adjusting means (17) of its own here. The transverse adjusting means is arranged in this case between the bracket (18) of the driving tools (4, 5) and the one-step or multistep carriage unit (9, 16). The transverse adjusting means has in turn a plate- or frame-like carrier for receiving the bracket (18) and a suitable, adjusting drive (26), e.g., an electric motor drive, along with mounting and guiding for the carrier. As an alternative, a plurality of driving tools (4, 5) may have a common transverse adjusting means and be arranged on a common subcarrier. A cross slide is obtained with the one-step or multistep carriage units (9, 16) combined with the transverse adjusting mechanism or means (17).

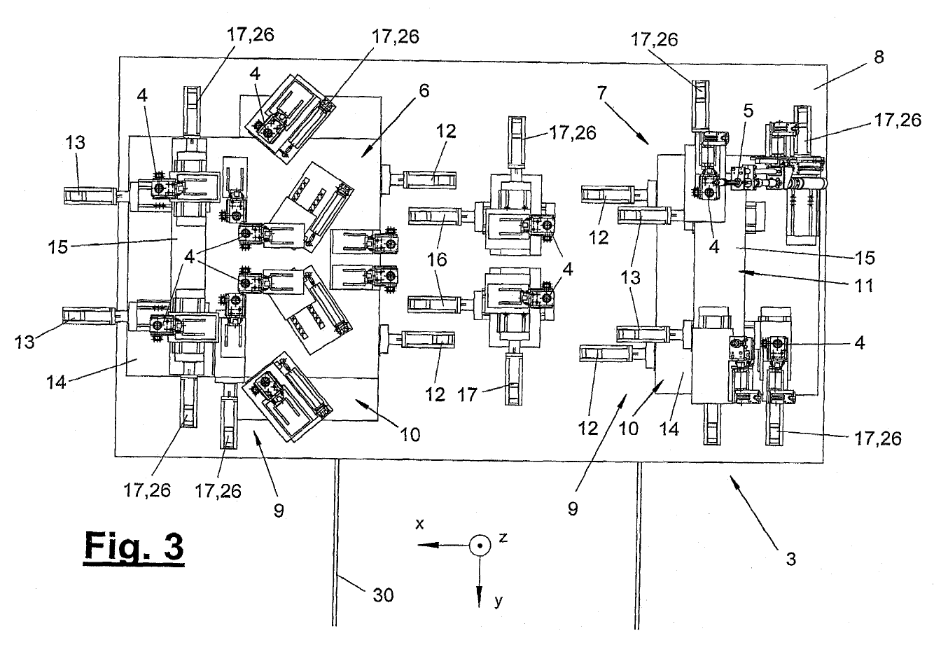

As is illustrated in FIG. 3, the travel paths of the transverse adjusting means (17) may also be directed obliquely. Moreover, the transverse adjusting means may have narrow bases or supports on the underside in order to make possible differences in height and a possible overlap in space with different carriage steps (10, 11).

FIG. 3 shows this arrangement at the left-hand driving group (6) with the upper and lower marginal driving tools (4), which are mounted with narrow supports on the lower carriage step (10) and project in height over the second carriage step (11), their transverse adjusting means being located above the second carriage step (11) and overlapping same in the top view.

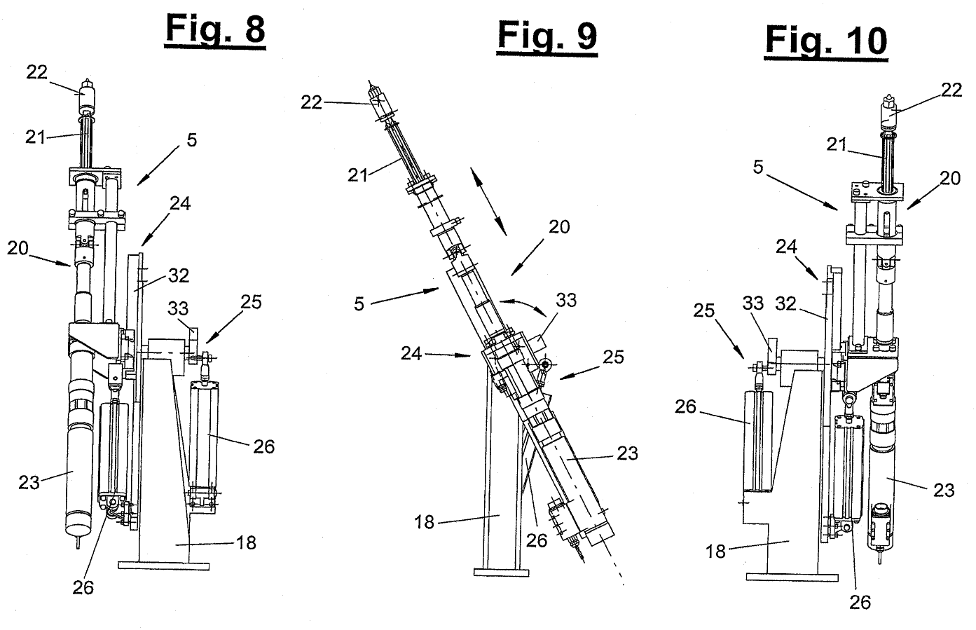

FIGS. 5 through 7 as well as FIGS. 8 through 10 show two variants of driving tools (4, 5) in detail and in different views. The first embodiment according to FIGS. 5 through 7 shows a driving tools (4) that is adjustable in height along the z axis. It comprises, e.g., an upright, column-like bracket (18), which is arranged on one of the adjusting means (9, 16, 17) or directly on the basic carrier (8). The driving unit (20) is mounted movably at the bracket (18) by means of a height adjusting means (24).

The driving unit (20) comprises, e.g., a driving spindle (21), which carries at its upper end a driving head (22), e.g., a screwdriver nut. A spindle drive (23) is arranged at the lower end of the driving spindle (21). The parts are connected to one another to form the driving unit (20) and are moved up and down as a unit by means of the height adjusting means (24). An adjusting guide (32), here a sliding guide, is arranged here at the bracket (18) with an adjusting drive (26), e.g., a cylinder or the like. The driving spindle (21) has a fixed length in this embodiment and is moved up and down together with the spindle drive (23) being carried. Another direction of motion is also possible in case of oblique direction of the sliding guide (32).

FIGS. 8 through 10 show a second variant with a pivotable driving tools (5). Both the above-described height adjusting means (24) and a pivoting adjusting means (25) are present here. As an alternative, there may also be a pivoting adjusting means (25) only. The height adjusting means (24) is mounted at the pivoting adjusting means (25) in the embodiment being shown and is rotated or pivoted together with same. An adjusting drive (26), e.g., a controllable cylinder, is arranged for this at the bracket (18), the adjusting drive (26) acting on the sliding guide (32), which is mounted at the bracket (18) pivotably about a horizontal axis, via a sliding guide (33), e.g., a crank. As an alternative, the adjusting drive (26) may have an electric stepping motor or another drive, which can be positioned multiply and accurately, in order to make it possible to precisely set any desired, different pivot angle of the driving unit (20) with the pivoting adjusting mechanism or means (25).

The adjusting means (9, 16, 17, 25) shown in FIGS. 2 through 4 offer various kinematic adjustment and motion possibilities for adaptation to different components or bodies (2). On the one hand, the driving tools (4, 5) integrated in one screwdriver group (6, 7) are mounted movably as a group or as a whole at the basic carrier (8) by means of an adjusting means (9). They are located together on a plate- or frame-like subcarrier (14, 15) and are moved with same, e.g., on the first carriage step (10). On the other hand, the driving tools (4, 5) can be additionally mounted movably and adjustably relative to one another within the screwdriver group (6, 7) by means of at least one auxiliary axis. Different possibilities are available for this in the exemplary embodiments.

This additional mobility may be given, e.g., by the relative motion of the carriage steps (10, 11). For example, a plurality of driving tools (4, 5), which form subgroups, are located on the subcarriers (14, 15) of the carriage steps (10, 11). The subgroups are adjusted in relation to one another by the motion of the carriage.

As an alternative or in addition, relative motions of the driving tools (4, 5) may take place within the screwdriver group (6, 7) or even within one or more of the above-mentioned subgroups due to the one or more transverse adjusting means (17). As an alternative or in addition, relative motion of the driving tools (4, 5) is possible due to the pivoting adjusting means (25).

The adjusting means (9, 16, 17) mounted on the surface of the basic carrier (8), especially the multistep carriage unit (9), make it, furthermore, possible to position the driving tools (4, 5) outside the edge of the carrier. The elimination of binding the position to the carrier geometry offers maximum flexibility and permits simple and inexpensive adaptation to new and larger components (2) while the existing basic carrier (8) is maintained.

The different drives (12, 13, 26) of the adjusting means (9, 16, 17, 24, 25) and also the spindle drives (23) are connected to a control (34), which is shown schematically in FIG. 1. It may be an independent control (34). As an alternative, the control may be integrated in an existing plant or station control or even in a robot control. The control is designed, e.g., as a numeric multi-axis control and may be, in particular, a robot control used for another purpose. In addition, the necessary operating material and energy supplies are present at the basic carrier (8).

The driver device (3) has, furthermore, a centering and lifting unit (27) arranged on the basic carrier (8). This [unit] comprises, e.g., four column-like frames, which are arranged at the corners of the carrier and extend upwardly in the direction of the z axis and have an introducing unit (28) with one or more oblique guiding surfaces at the upper free end. The introducing unit is connected to a lifting device (29) and can be raised and lowered in the direction of the z axis in a remote-controlled manner and optionally in cooperation with the control (34). The introducing units (28) mesh with the spindle frame (35) or alternatively with the components (2) and with a separate aggregate carrier. It is possible with the introducing unit (28), which is movable in height, to detach the spindle frame (35) or the components or component carriers from the initial position and from their conveyor and to position them opposite the driver device (3), and especially to center them. As a result, the necessary assignment is created in space between the driving tools (4, 5) and the corresponding driving points at the spindle extensions of the spindle frame (35) or at the components (2). Due to the adjusting means (24, 25), the driving heads (22) can then be extended from their withdrawn inoperative position and brought into the operating position and meshed with the driving points. Oblique feed is also possible now by means of the pivoting adjusting means (25) or inclined bases (19) or brackets (18).

The individual driving tools (4, 5) can perform a plurality of driving operations during the machine cycle and can be displaced in the process between the individual operations by means of the adjusting means (9, 16, 17) on the basic carrier (8) with a correspondingly accurate position control and suitable position transducers. The driving heads (22) can be equipped with suitable driving means in case of direct driving during the ancillary times when the components (2) are changed. The driving unit (3) may optionally also be moved laterally somewhat out of the driving station (1) for this.

The individual driving tools (4, 5) are preferably adapted to one another in height by corresponding bases (19) or the like such that an interference contour of essentially the same height is obtained with their upper ends or driving heads (22). The length of the brackets (18) and the height of the bases (19) is preferably selected to be such that a sufficiently large space is obtained for movement for workers under the components (2) in the driving station (1) when the driver device (3) is moved out of the driving station (1) in case of disturbance or for other reasons and there is a changeover to manual screwdriver operation.

Various modifications of the embodiments shown are possible. The different variants shown may be transposed or combined with one another as desired. This also applies to the individual design features of the different embodiment variants. The number and the arrangement of the driving tools (4, 5) and of the adjusting means (9, 16, 17, 24, 25) may vary as described. The kinematic assignment of the longitudinal and transverse adjusting means (16, 17) may be transposed, in which case the transverse adjusting means (17) is arranged on the basic carrier (8) and it carries the longitudinal adjusting means (16).

Mounting grids, e.g., screw hole grids, may be present on the plate- or frame-like subcarriers (14, 15) or on the carriers of the longitudinal and transverse adjusting means (16, 17). Furthermore, adapters may be present to change and adapt the positions of the driving tools (4, 5) to these mounting grids. The projection can also be changed and a driver tools (4, 5) can be arranged outside the carrier contour with adapters.

As an alternative, the centering and lifting unit (27) may be eliminated. Furthermore, design modifications of the assembly units described are possible.

The reference to a driving station (1) and a driver device (3) along with driving tools (4, 5) also comprises any other desired types of joining and assembly means and joining or assembly tools.

While a specific embodiment of the invention has been shown and described in detail to illustrate the application of the principles of the invention, it will be understood that the invention may be embodied otherwise without departing from such principles.

1. An automatic driver device (3) for joining components, in a driving station the driver device comprising:
a basic carrier;
a plurality of automatic driver tools mounted thereon on said basic carrier
an adjusting means, said automatic driver tools being movable along a plurality of axes by means of said adjusting means said plurality of driver tools being integrated in at least one screwdriver group and being mounted together movably at the basic carrier by means of said adjusting means.

2. A driver device in accordance with claim 1, wherein said driver tools are additionally mounted movably in relation to one another by means of said adjusting means within said screwdriver group.

3. A driver device in accordance with claim 1 wherein said adjusting means comprises a multistep carriage unit that can be telescoped or cascaded.

4. A driver device in accordance with claim 3, wherein the carriage unit has a plurality of said carriage steps that are movable relative to one another along at least one axis.

5. A driver device in accordance with claim 4, wherein the carriage steps are mounted next to each other.

6. A driver device in accordance with claim 4, wherein at least one said carriage step has a plate- or frame-like subcarrier with a plurality of said driver tools integrated in a screwdriver group.

7. A driver device in accordance with claim 1, wherein at least one said driver tools from the screwdriver group is arranged on at least one next carriage stage and/or on a transverse adjusting portion of said adjusting means.

8. A driver device in accordance with claim 4, wherein the carriage steps have controllable carriage drives of their own.

9. A driver device in accordance with claim 1, wherein said adjusting means has a smaller width and length than the basic carrier.

10. A driver device in accordance with claim 3, wherein a plurality of said carriage units are arranged next to each other on the basic carrier.

11. A driver device in accordance with claim 3, wherein said adjusting means has, for each said driver tools, a linear transverse adjusting means with a controllable adjusting drive.

12. A driver device in accordance with claim 11, wherein the transverse adjusting means is arranged between the driver tools and the multistep carriage unit or a one-step longitudinal adjusting means.

13. A driver device in accordance with claim 1, wherein the driver tools has a bracket and a driving unit movable thereon along one or more axes.

14. A driver device in accordance with claim 13, wherein a height adjusting means is arranged between the bracket and the driving unit.

15. A driver device in accordance with claim 13, wherein a pivoting adjusting means is arranged between the bracket and the driving unit.

16. A driver device in accordance with claim 13, wherein the driving unit has a driving spindle with a driving head and with a carried spindle drive.

17. A driver device in accordance with claim 1, wherein the basic carrier has a plate- or frame-like design.

18. A driver device in accordance with claim 1, wherein the basic carrier has a chassis and a rail guide, for withdrawing and extending from the driving station.

19. A driver device in accordance with claim 1, wherein the basic carrier has a centering and lifting unit.

20. A driver device in accordance with claim 19, wherein the centering and lifting unit comprises a plurality of introducing units with said lifting devices.

21. A driver device in accordance with claim 1, further comprising: a control connected to said adjusting means and spindle drives of said driving unit.

22. A driver device in accordance with claim 21, wherein the control comprises a numeric multi-axis control.

23. A driving station for joining said components of vehicle bodies, the station comprising:
an automatic driver device comprising a basic carrier, a plurality of automatic driver tools mounted on said basic carrier and an adjusting means, said automatic driver tools being movable along a plurality of axes by means of said adjusting means, said plurality of driver tools being integrated in at least one screwdriver group and being mounted together movably at said basic carrier by means of said adjusting means.

24. A driving station in accordance with claim 22, wherein a spindle carrier is arranged between the components and the driver device.

25. A process for joining said components of vehicle bodies, in a driving station with an automatic driver, the process comprising providing a basic carrier with a plurality of automatic driver tools mounted movably along multiple axes thereon by means of an adjusting means; and integrating said plurality of driver tools in a screwdriver group and are adjusted together by means of said adjusting means.

26. A process in accordance with claim 25, wherein one or more said driver tools are additionally adjusted relative to one another by means of said adjusting means within the screwdriver group.
